(19) United States
(12) Patent Application Publication
(10) Pub. No.: US 2016/0309403 A1
(43) Pub. Date: Oct. 20, 2016

(54) Control System for Air Wave Detecting and Control Method Thereof

(71) Applicant: Mercue Inc., New Taipei City (TW)

(72) Inventors: Fu-Yu Huang, New Taipei City (TW); Feng Hui Kuan, New Taipei City (TW)

(21) Appl. No.: 15/052,965

(22) Filed: Feb. 25, 2016

Related U.S. Application Data
(60) Provisional application No. 62/120,949, filed on Feb. 26, 2015.

(51) Int. Cl. H04W 48/16; H04W 4/20; H04W 4/04

(52) U.S. Cl. CPC H04W 48/16; H04W 4/043; H04W 4/206; H04W 4/008

(57) ABSTRACT

A control system for detecting air wave is provided and applied to an electronic device. The control system for detecting air wave includes a detecting module, at least one first application and a service module. The detecting module is configured to detect an air wave and transform the air wave into an electronic signal. The service module includes a service scheduling module and a decoding module. The service scheduling module controls the detecting module to obtain the electronic signal. The decoding module decodes the electronic signal to a digital content. The digital content is transmitted to the corresponding first application.

### FIELD OF THE INVENTION

The present invention relates to a control system for detecting air wave, particularly to a method that can control and turn on applications via detecting air wave.

### BACKGROUND OF THE INVENTION

“Beacon” is a mini Bluetooth signal transmitter that has many advantages such as small volume, low power consumption and longevity, etc. Beacon usually is disposed on the shopping mall or the trade area and used for indoor position or advertising information broadcasting/sending. For example, the phone of the consumer would receive Bluetooth signal of Beacon and display some information such as discount information when the consumer is in Beacon broadcasting/sending range. The indoor position uses a plurality of Beacon in which its location is predetermined to calculate the position of consumer and provides the service of position or route guidance.

Beacon can increase added value of the shopping mall or the shopping district, but the consumer needs to turn on Bluetooth function of phone so as to receive signal of Beacon. However, the Bluetooth function would make battery power of phone exhausted rapidly. Moreover, if Bluetooth and Wi-Fi are launched simultaneously, one of them would be disconnected. Therefore, the consumer would not turn on Bluetooth function of phone in general condition. Thus, the shopping mall or the shopping district needs to additionally provide discount or marketing campaign so as to encourage the consumer to turn on the Bluetooth function.

A method is provided for solving the problem in the prior art. The method is a way to transmit a digital content via the air wave including a feature. When the microphone of phone receives the air wave, the air wave would be reverted to a digital signal. Thus, when the phone receives the air wave such as a specific sound signal, the phone would turn on the Bluetooth function. However, in the architecture of the prior art, multiple applications can access the microphone individually, but microphone can only be accessed by only one application at one time. If the microphone is accessed by multiple applications simultaneously, an error would be occurred, leading to the microphone not accessed. By that, the phone would not turn on its Bluetooth function.

In summary, how to solve above-said problem and provide a method of assigning the access right of microphone adequately is worth considering to a person having ordinary skills in the art.

### SUMMARY OF THE INVENTION

According to the above-said problem, the present invention provides a control system for detecting air wave which can control the application via an air wave including a feature.

A control system for detecting air wave is provided. The control system for detecting air wave is used to an electronic device and the control system for detecting air wave comprises a detecting module, at least one first application and a service module. The detecting module detects an air wave including a feature and transforms the air wave into an electronic signal. The service module comprises a service scheduling module and a decoding module. The service scheduling module controls the detecting module in order to receive the electronic signal. The decoding module decodes the electronic signal to a digital content, and the decoding module transmits the digital content to the corresponding first application.

A control system for detecting air wave is provided. The control system for detecting air wave is used to an electronic device and the control system for detecting air wave comprises a detecting module and at least one first application. The detecting module detects an air wave and transforms the air wave including a feature into an electronic signal. The first application comprises a service module, and a decoding module. The service scheduling module controls the detecting module in order to receive the electronic signal. The decoding module decodes the electronic signal to a digital content, and the digital content is transmitted to the corresponding first application.

In the above control system for detecting air wave, the service scheduling module controls the detecting module to detect the air wave based on time.

In the above control system for detecting air wave, the service scheduling module obtains a location information via the electronic device; if the location information is consistent with a predestinate condition, the service module controls the detecting module to detect the air wave.

In the above control system for detecting air wave, the digital content comprises at least one application identifier.

In the above control system for detecting air wave, after the electronic signal is decoded by the decoding module, a wireless communication module of the electronic device is turned on.

In the above control system for detecting air wave, after the decoding module receives the electronic signal, a display screen of the electronic device displays a wireless communication turn-on permission request.

In the above control system for detecting air wave, after the corresponding first application receives the digital content, the wireless communication module of the electronic device is turned on.

In the above control system for detecting air wave, the service module and the detecting module can be executed while the first application is not turned on.

A method of turning on an application is provided, the method of turning on an application comprises:

S10: detecting an air wave by a detecting module;

S20: transforming the air wave into an electronic signal by the detecting module;

S30: receiving the electronic signal by at least one decoding module;

S40: decoding the electronic signal to receive a digital content by the decoding module;

S50: transmitting the digital content to the corresponding first application by the decoding module.

The above method of turning on an application, further comprises:

S31: turning-on a wireless communication module of an electronic device by the decoding module.

The above method of turning on an application further comprises:

S31: displaying a wireless communication turn-on permission request on a display screen of an electronic device by the detecting module.

The above method of turning on an application further comprises:

S51: turning on a wireless communication module of an electronic device by the first application.

In the above method of turning on an application, wherein, in the step S10, a service scheduling module controls the detecting module to detect the air wave based on time.

The above method of turning on an application further comprises:

S01: obtaining a location information via an electronic device by at least one service scheduling module;

S02: determining the location information;

S03: if the location information is consistent with a predestinate condition, the service scheduling module controls the detecting module to detect the air wave.

In the above method of turning on an application, in the step S50, the decoding module transmits the digital content based on an application identifier in the digital content.

In the above method of turning on an application, in the step S50, the decoding module transmits the digital content to the corresponding first application via at least one service module.

In the above method of turning on an application, the service modules can transmits information to each other.

In the above method of turning on an application, the service scheduling module can assigns using rights of the detecting modules.

### BRIEF DESCRIPTION OF THE DRAWINGS

FIG. 1 shows the control system for detecting air wave of the present invention.

FIG. 2 shows a diagram of how to identify the first application.

FIG. 3 shows a control system for detecting air wave of another embodiment.

FIG. 4A-4D shows a method of turning on an application.

### DESCRIPTION OF THE PREFERRED EMBODIMENTS

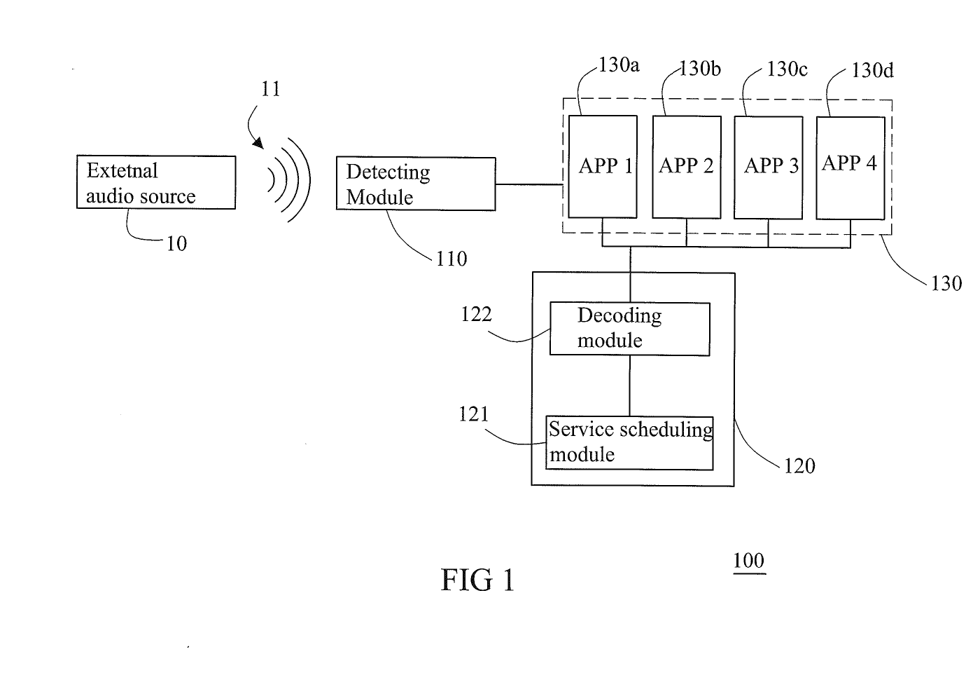

Please refer to FIG. 1. FIG. 1 shows the control system for detecting air wave 100 of the present invention and an external audio source 10. The control system for detecting air wave 100 is used to an electronic device. In this embodiment, the electronic device is a smart phone, a tablet PC or an electronic device having computing unit (e.g. MCU, DSP or CPU). The control system for detecting air wave 100 includes at least one first application 130, a detecting module 110 and a service module 120. The detecting module 110 is a microphone, a microphone array, or an air vibration ADC (analog to digital) device. The detecting module 110 can detects and receives air wave 11 including a feature from the external audio source 10. For example, the audio source 10 is a broadcast system of shopping mall, a speaker of store or an audio player, etc, so the air wave 11 is the sound signal transmitted from the external audio source 10. After the detecting module 110 receives the air wave 11, the air wave 11 including a feature would be converted into an electronic signal by the detecting module 110 and be processed in sequence by the service module 120. The first application 130 is installed in the electronic device such as APP. In this embodiment, the number of the first application 130 in the electronic device is one or multiple.

The service module 120 and the first application 130 can quickly access the variables of each other. For example, the first application 130 can quickly access the digital content obtained by the service module 120. Beside, the service module 120 and the first application 130 can call each other so as to achieve communication and coordination between the service module 120 and the first application 130. For example, the service module 120 can turn on the first application 130.

The service module 120 includes a service scheduling module 121 and a decoding module 122. The service scheduling module 121 controls the detecting module 110 in order to receive the electronic signal. In other words, the service scheduling module 121 can turn-on or turn-off the detecting module 110 based on different conditions. The service scheduling module 121 also can assign the using right/permission of detecting module 110 to different first applications 130 so as to avoid a plurality of first application 130 occupying/seizing the using right/permission of detecting module 110 simultaneously. After turn-on, the detecting module 110 is able to receive air wave 11 and transform the air wave 11 into the electronic signal.

In this embodiment, the service scheduling module 121 can assign the using right to different first application 130. For example, when any first application 130 is not turned on, the first application 130a keeps on using the detecting module 110. In the above-said process, the service scheduling module 121 coordinates the detecting module 110 with each first application 130a-130d and assigns the received electronic signal.

In another embodiment, when any first application 130 is not turned on, the first application 130a firstly uses the detecting module 110 for 2 seconds, and then the first application 130b uses the detecting module 110 for 2 seconds, and after that the first application 130c uses the detecting module 110 for 2 seconds, and then the first application 130d uses the detecting module 110 for 2 seconds. In other words, the first applications 130a-130d in turn uses the detecting module 110. In the above-said process, the service scheduling module 121 coordinates the detecting module 110 with each first application 130a-130d and assigns the received electronic signal.

In the other embodiment, the first application 130a is turned on and uses the detecting module 110 until the first application 130a is closed. And then, the first application 130b would use the detecting module 110 for 2 seconds after the first application 130a is closed, and after that the first application 130c would use the detecting module 110 for 2 seconds. In the above-said process, the service scheduling module 121 coordinates the detecting module 110 with each first application 130a-130c and assigns the received electronic signal.

In some embodiment, the service scheduling module 121 obtains location information via the electronic device. The service scheduling module 121 determines whether the location information is consistent with a predestinate condition or not. If the location information is consistent with the predestinate condition, the service scheduling module 121 would turn on the detecting module 110 to detect the air wave 11. For example, when the user having the electronic device walks into a specific store, the service scheduling module 121 would turn on the detecting module 110 so as to detect and determine whether the music or voice comprises the air wave 11 including a feature or not.

After the detecting module 110 detects the air wave 11, the air wave 11 would be converted into an electronic signal, and the electronic signal would be transmitted to the decoding module 122. The electronic signal is a coded or encrypted signal and can be decoded, resolved or reverted by the decoding module 122 in order to generate a digital content that can be read by the service module 120 and the first application 130. Thus, the decoding module 122 can transmit the digital content to the corresponding first application 130.

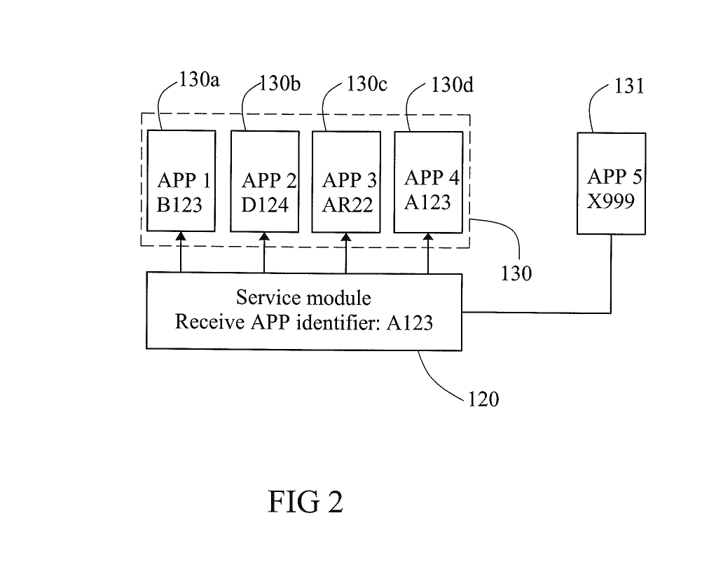

Please refer the FIG. 2. FIG. 2 shows a diagram of how to identify the first application 130. In some embodiment, the digital content includes an application identifier. The service module 120 transmits the digital content to the corresponding first application 130 based on the application identifier. For example, in FIG. 2, the application identifier in the digital content obtained by the service module 120 is A123, so the service module 120 would transmit the digital content to the first application 130d whose application identifier is A123. The first application 130a-130c cannot receive the digital content because their application identifiers are not A123. In other example, in FIG. 2, the digital content obtained by the service module 120 includes an application identifier, and the application identifier is 123. The service module 120 would transmit the digital content to the first application 130a and 130d whose application identifiers are 123, and the other first application 130b and 130c would not receive the digital content. In another example, in FIG. 2, the application identifier in the digital content obtained by the service module 120 is X999. The service module 120 would transmit the digital content to a second application 131 which does not have the using right/permission of the service module 120 or the detecting module 110.

Furthermore, after the decoding module 122 receives electronic signal, the wireless communication module (Bluetooth, Wi-Fi, or NFC, etc.) of the electronic device would be turned on. Thus, the first application 130 can receive the wireless signal via the wireless communication module, and the wireless signal is particularly a signal transmitted from a stationary wireless signal transmitter. For example, by turning on the Bluetooth device, the first application 130 can scan the ibeacon near the electronic device and execute the related function.

In other embodiment, after the decoding module 122 decodes the electronic signal to the digital content, the corresponding first application 130 would turn on the wireless communication module. In other words, the control system for detecting air wave 100 can turn on the corresponding first application 130 via the air wave 11 and the wireless communication module, so that the first application 130 can execute the related function via the wireless communication module.

In some embodiment, after the decoding module 122 receives the electronic signal, a wireless communication turn-on permission request is shown on a display screen of the electronic device for reminding the user to turn on the wireless communication module, so that the first application 130 can receive the signal via the wireless communication module.

Furthermore, the service module 120 and the detecting module 110 of the control system for detecting air wave 100 can be operated independently in the background of the electronic device. In other words, the service module 120 and the detecting module 110 detect the air wave 11 when the first application 130 is turned off. After the service module 120 and the detecting module 110 detect the air wave 11 including a feature, the first application 130, especially used in the special field, is turned on and working normally.

For example, a shopping mall uses the ibeacon to provide some service such as indoor position, mall guide or discount information etc, and the above-said services are provided by using the first application 130. When the user walks into the shopping mall and brings an electronic device having the control system for detecting air wave 100, the control system for detecting air wave 100 would receive the air wave 11 at the shopping mall via the detecting module 110. The air wave 11 is such as the music, the broadcast, or the sound at the shopping mall. The service scheduling module 121 would turn on the detecting module 110 based on the above-said condition. After the detecting module 110 receives and converts the air wave 11 into an electronic signal, the electronic signal would be converted into a digital content by the decoding module 122, the digital content would be transmitted to and for turning on the first application 130, and at the same time the Bluetooth device of electronic device is also turned on. Turning on method of the Bluetooth device is described as above, for example the Bluetooth device can be turned on by the service module 120, by the first application 130, or by the user who is reminded by the permission request shown on the electronic device. Thus, the user can use the service from the shopping mall via the Bluetooth device.

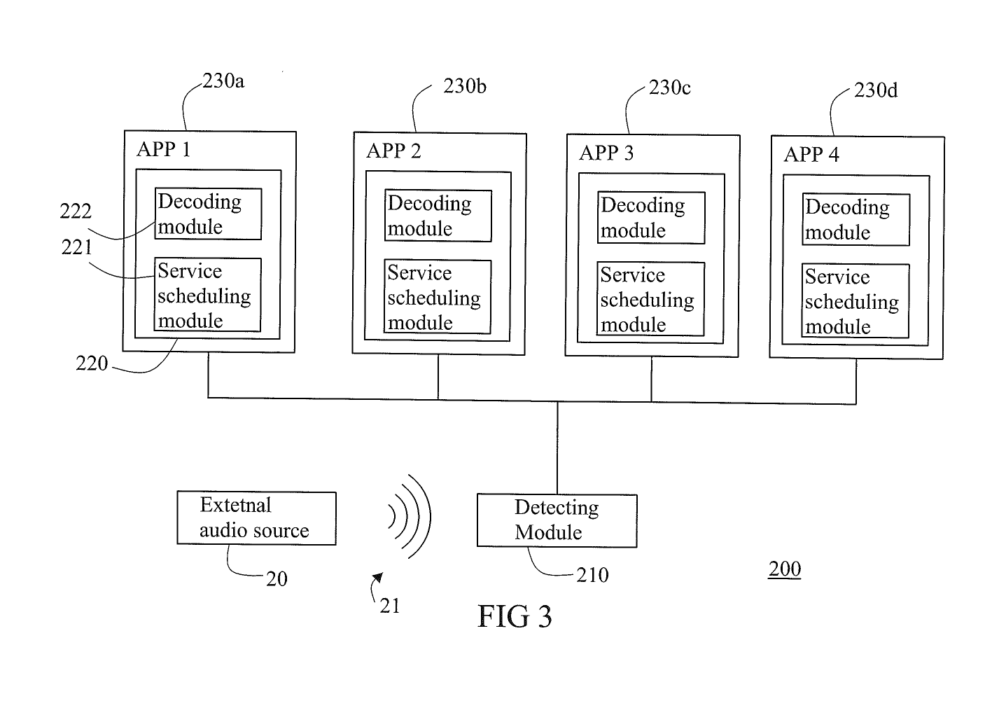

Please refer the FIG. 3. FIG. 3 shows a control system for detecting air wave 200 and an external audio source 20 in another embodiment. In the embodiment of FIG. 3, the control system for detecting air wave 200 includes a detecting module 210 and at least one first application 230. Each first application 230 includes a service module 220. The service module 220 includes a decoding module 222 and a service scheduling module 221. The functions of the decoding module 222 and the service scheduling module 221 are described in the above-said embodiment and not explained here again. Particularly, in this embodiment, each first application 230 includes the service module 220. The service module 220 is such as Software Development Kit (SDK) and embedded into the first application 230. Those service modules 220 can transmit information into each other and coordinate the using right of detecting module 210 with each first application 230. For example, each first application 230 uses the detecting module 210 in turn. When the detecting module 210 receives the air wave 21, the air wave 21 would be decoded and transmitted to the corresponding first application 230. Multiple service modules 220 are disposed so as to prevent a plurality of first application 230 from occupying/seizing the using right of the detecting module 210 simultaneously and thus the function of the first application 130 can work normally.

In this embodiment, each service scheduling module 221 coordinates and assigns the using right of the detecting module to different first application 130. For example, when any first application 230 is not turned on, the first application 230a uses the detecting module 210 for 2 seconds, and then the first application 230b uses the detecting module 210 for 2 seconds, and after that the first application 230c uses the detecting module 210 for 2 seconds. And then the first application 230d uses the detecting module 210 for 2 seconds. In other words, the first applications 230a-230d in turn uses the detecting module 210.

In another embodiment, the first application 230a is turned on and uses the detecting module 210 until the first application 230a is closed. After that, the first application 230b would use the detecting module 210 for 2 seconds after the first application 230a is closed, and then the first application 230c would use the detecting module 110 for 2 seconds. In other words, the first applications 230a-230c in turn uses the detecting module 210.

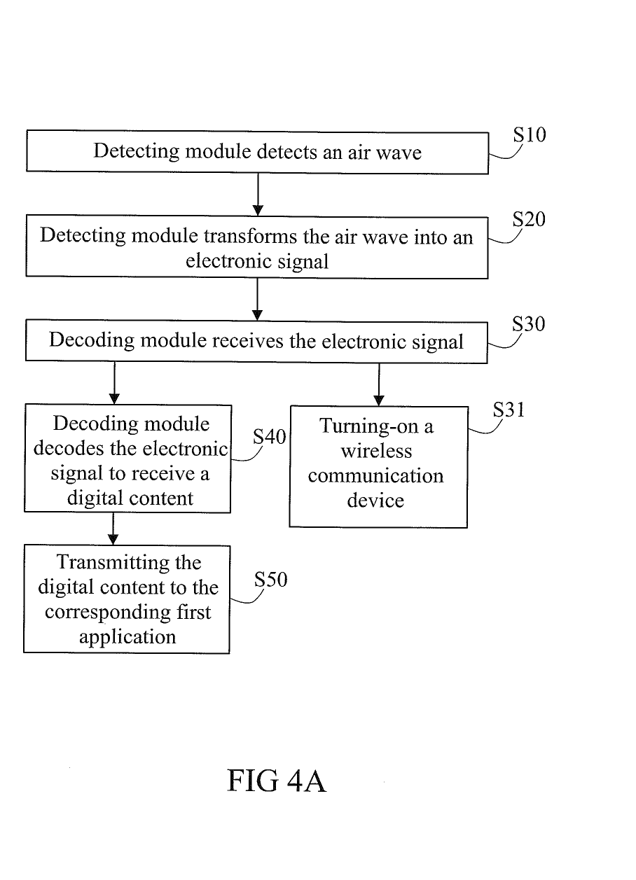

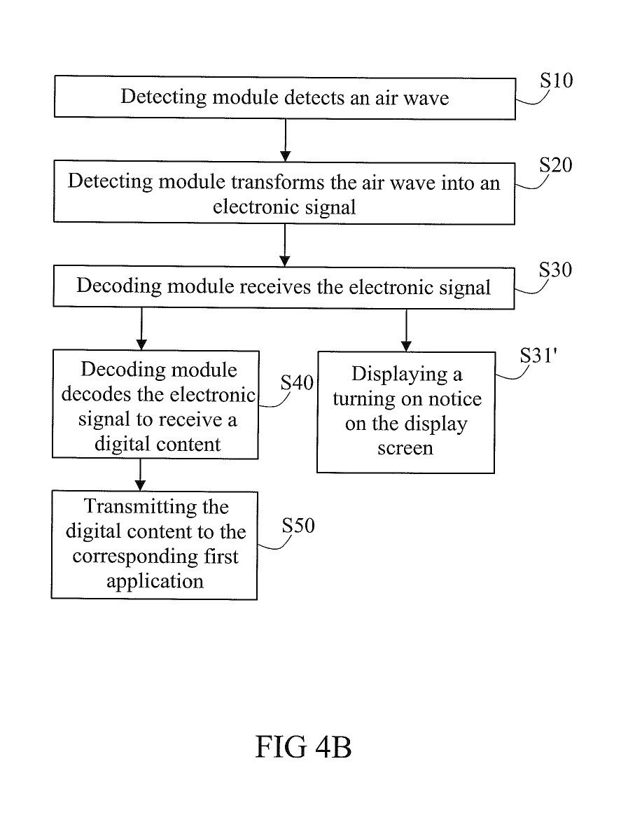

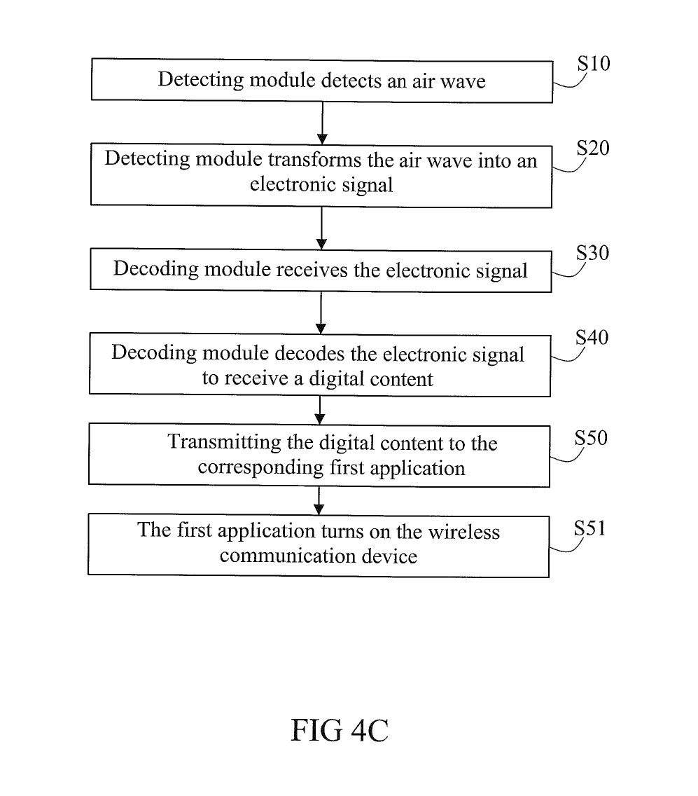

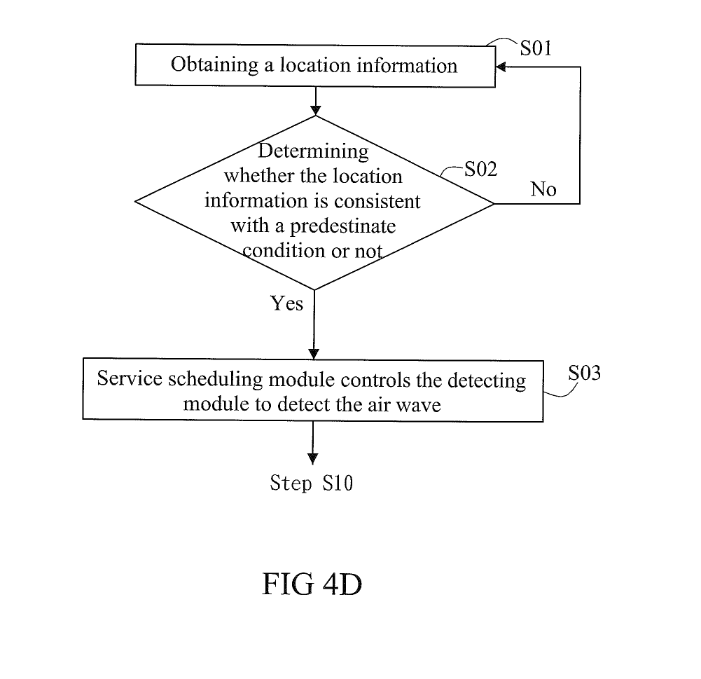

Please refer the FIG. 4A-4D. The FIG. 4A-4D shows a method of turning on an application. First, a detecting module 110 detects an air wave 11 (step S10). The detecting module 110 is such as a microphone and the air wave is such as an audio signal. In the step S10, the detecting module 110 is controlled to detect air wave 11 by the service scheduling module 121 based on schedule. Then, the detecting module 110 converts the air wave 11 into an electronic signal (step S20). Next, at least one decoding module 122 receives the electronic signal (step S30). Next, the decoding module 122 decodes the electronic signal to a digital content (step S40). Then, the decoding module 122 transmits the digital content to the first application 130 corresponding the digital content (step S50). The digital content includes an application identifier. The decoding module 122 transmits the digital content to the first application 130 having corresponding application identifier. Beside, in the embodiment of FIG. 3, after the decoding module 122 obtained the digital content, the digital content would be transmitted into the first application 130 via at least one service module 120. For example, the decoding module 231 of the first application 230a obtains a digital content, and the digital content can be transmitted to another first application 230b. After the decoding module 122 receives the electronic signal, the wireless communication device of electronic device would be turned on (Step S31). Thus, the first application 130 can use the wireless communication device. In some embodiment, in the step S30, the service scheduling module controlling the detecting module to detect the air wave is based on schedule.

In some embodiment, the decoding module 122 would display a wireless communication turn-on permission request on the display screen (shown in FIG. 4B, Step S31′). The wireless communication turn-on permission request reminds the user to turn on the wireless communication device or reminds the wireless communication device would be automatically turned on soon.

Beside, in another embodiment, after the first application 130 receives the digital content, the first application 130 would turn on the wireless communication device (shown in FIG. 4C, Step S51).

Please refer to FIG. 4D. In the embodiment of FIG. 4D, the service scheduling module 121 would obtain a location information via the electronic device before the detecting module 110 detects air wave 11 (step S01). For example, the location information can be obtained by GPS, DGPS, AGPS or network position such as GSM, CDMA, Wi-Fi etc. Next, the service scheduling module 121 would determine whether the location information is consistent with predestinate condition or not (step S02). The location information is such as a GPS coordination (such as 120° 58′ 25.9750″, 23° 58′ 32.3400″ or 247342.198, 2652335.851), a IP Address, or a MAC Address of Wi-Fi Access Point (such as 10-78-D2-93-58-C2). The predestinate condition is for example: being consistent with or near specific GPS coordination, or being consistent with IP Address or MAC Address. If the location information is not consistent with the predestinate condition, the step S01 would be carried out again to keep on obtaining new location information. If the location information is consistent with the predestinate condition, the service scheduling module 121 controls the detecting module 110 to detect the air wave 11 (Step S03).

The control system for detecting air wave 100 of the present invention can turn on the first application 130 of electronic device via air wave 11, and the using right/permission of detecting module can be appropriately assigned by the service module 120, thus to avoid the application occupying/seizing the using right of detecting module 110 simultaneously. Beside, the control system for detecting air wave 100 can automatically turn on the wireless communication module of electronic device so that the first application 130 could receive wireless signal via the wireless communication module, so as to expand the application range of the stationary wireless signal transmitter.

Those skilled in the art will readily observe that numerous modifications and alternatives of the device and method may be made while retaining the teachings of the invention. Accordingly, the above disclosure should be construed as limited only by the meters and bounds of the appended claims.

### REFERENCE NUMBER LISTING

10, 20: external audio source
11, 21: air wave
100, 200: control system for detecting air wave
110, 210: detecting module
120, 220: service module
121, 221: service scheduling module
122, 222: decoding module
130, 130a-130d, 230, 230a-230d: first application
131: second application
S01˜S51: steps in the flowchart.

1. A control system for detecting air wave used to an electronic device and the control system for detecting air wave comprising:
a detecting module detecting an air wave including a feature and the detecting module transforming the air wave into an electronic signal;
at least one first application; and
a service module comprising:
a service scheduling module controlling the detecting module in order to receive the electronic signal; and
a decoding module decoding the electronic signal to a digital content, and the decoding module transmitting the digital content to the corresponding first application.

2. (canceled)

3. The control system for detecting air wave of claim 1, wherein the service scheduling module controls the detecting module to detect the air wave based on time.

4. The control system for detecting air wave of claim 1, wherein the service scheduling module obtains a location information via the electronic device; when the location information is consistent with a predestinate condition, the service module controls the detecting module to detect the air wave.

5. The control system for detecting air wave of claim 1, wherein the digital content comprises at least one application identifier.

6. The control system for detecting air wave of claim 1, wherein after the electronic signal is decoded by the decoding module, a wireless communication module of the electronic device is turned on.

7. The control system for detecting air wave of claim 1, wherein after the decoding module receives the electronic signal, a display screen of the electronic device displays a wireless communication turn-on permission request.

8. The control system for detecting air wave of claim 1, wherein after the corresponding first application receives the digital content, the wireless communication module of the electronic device is turned on.

9. The control system for detecting air wave of claim 1, wherein the service module and the detecting module can be executed while the first application is not turned on.

10. A method of turning on application comprising:
S10: detecting an air wave by a detecting module;
S20: transforming the air wave into an electronic signal by the detecting module;
S30: receiving the electronic signal by at least one decoding module;
S40: decoding the electronic signal to a digital content by the decoding module;
S50: transmitting the digital content to the corresponding first application by the decoding module.

11. The method of turning on application of claim 10 further comprising:
S31: turning on a wireless communication module of an electronic device by the decoding module.

12. The method of turning on an application of claim 10 further comprising:
S31: displaying a wireless communication turn-on permission request on a display screen of an electronic device by the detecting module.

13. The method of turning on application of claim 10 further comprising:
S51: turning on a wireless communication module of an electronic device by the first application.

14. The method of turning on application of claim 10, wherein, in the step S10, a service scheduling module controls the detecting module to detect the air wave at regular time.

15. The method of turning on application of claim 10, further comprising:
S01: obtaining a location information via an electronic device by at least one service scheduling module;
S02: determining the location information; and
S03: if the location information is consistent with a predestinate condition, the service scheduling module controls the detecting module to detect the air wave.

16. The method of turning on an application of claim 10, wherein, in the step S50, the detection module transmits the digital content based on an application identifier of the digital content.

17. The method of turning on application of claim 10, wherein, in the step S50, the detecting module transmits the digital content to the corresponding first application via a service module.

18. A control system for detecting air wave used to an electronic device and comprising:
a detecting module detecting an air wave including a feature and the control system for detecting air wave transforming the air wave into an electronic signal; and
at least one first application comprising:
a service module comprising:
a service scheduling module controlling the detecting module in order to receive the electronic signal; and
a decoding module decoding the electronic signal to a digital content, and the detecting module transmitting the digital content to the first application corresponding the digital content.

19. The control system for detecting air wave of claim 18, wherein the service scheduling module controls the detecting module to detect the air wave based on time.

20. The control system for detecting air wave of claim 18, wherein the service scheduling module obtains a location information via the electronic device; when the location information is consistent with a predestinate condition, the service module controls the detecting module to detect the air wave.

21. The control system for detecting air wave of claim 18, wherein the digital content comprises at least one application identifier.

22. The control system for detecting air wave of claim 18, wherein after the electronic signal is decoded by the decoding module, a wireless communication module of the electronic device is turned on.

23. The control system for detecting air wave of claim 18, wherein after the decoding module receives the electronic signal, a display screen of the electronic displays a wireless communication turn-on permission request.

24. The control system for detecting air wave of claim 18, wherein after the corresponding first application receives the digital content, the wireless communication module of the electronic device is turned on.

25. The control system for detecting air wave of claim 18, wherein the service module and the detecting module can be executed while the first application is not turned on.
